(19) United States
(12) Patent Application Publication
(10) Pub. No.: US 2008/0280374 A1
(43) Pub. Date: Nov. 13, 2008

(54) METHODS AND SYSTEMS FOR DETECTING BIOLOGICAL AND CHEMICAL MATERIALS ON A SUBMICRON STRUCTURED SUBSTRATE

(75) Inventors: RADISLAV ALEXANDROVICH POTYRAILO, NISKAYUNA, NY (US); EUGENE BARASH, NISKAYUNA, NY (US); KATHERINE DOVIDENKO, REXFORD, NY (US); PETER WILLIAM LORRAINE, NISKAYUNA, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/745,827

(22) Filed: May 8, 2007

(51) Int. Cl. G01N 21/76

(52) U.S. Cl. 436/172; 422/82.05

(57) ABSTRACT

Methods and systems for detecting biological or biochemical analytes generally comprising, a metal film having one or more surfaces comprising one or more submicron structures; a device for applying one or more analytes to at least a portion of the film surface to interact with said metal film; a light source for illuminating a surface of the metal film so that at least some of the light is adapted to be optically altered by the functionalized metal film; and an optical detection subsystem for collecting the optically altered light, wherein the altered light is indicative of surface plasmon resonance on the film, and detecting one or more properties of the analytes based on the collected light.

### BACKGROUND

The invention relates generally to sensor based methods and devices for quantification of chemical and biological materials suspended or otherwise present in fluids and then immobilized on a submicron structured film.

Metal-film based sensors used or known today take advantage of a surface plasmon resonance (SPR) effect. As surface plasmon resonance effect is the result of surface plasmons, which are essentially waves of light that propogate along or across the surface of a conductive surface, typically metal. These waves interact with free electrons on the surface of the conductive materials, which in turn oscillate in resonance with the waves of light. The properties of this resonance effect are dependent on various factors that can be manipulated and measured for a variety of different applications.

The light intensity or wavelength changes in these sensors are measured as a function of the complex refractive index of the proximal sample. These sensors are widely used to study bio-chemical reactions. However, a known limitation of this conventional SPR technique is its relatively low sensitivity, which is typically between 10⁻³-10⁻⁵ refractive index units (RIU) although the sensitivity can, in some circumstances, be improved up to 10⁻⁶ RIU. However, for modern demanding bio-chemical applications, a sensitivity of about 10⁻⁹ RIU or better is essential. Thus, a more advanced SPR technique has been applied in bio-chemical sensors. This more advanced SPR technique is based on the application of the Goos-Hänchen (GH) effect. In some sensors, the GH effect is small and not useful for sensing measurements. In other sensors, the GH effect is more substantial and is used to improve evanescent-wave propagation.

Previously reported GH SPR demonstrations use a solid metal film such as gold, silver or platinum. The refractive index (RI) resolution of these solid metal film sensors was reported as approximately 10⁻⁸ RIU which, although better, are still insufficient for demanding bio-chemical applications. Different types of phase detection have also been reported including interferometric, heterodyne, and others.

### BRIEF DESCRIPTION

One or more of the embodiments of the methods and systems overcome the problems of existing GH-SPR techniques in part by eliminating the need for a coupling prism-based configuration and by improving the sensitivity or detection limits of SPR based sensors. One or more of the embodiments of the methods and systems creates a specific pattern of submicron structures on a metal film. These sensor arrays of generally sub-wavelengths apertures provide previously unavailable properties for optical systems, including, but not limited to, extraordinary optical transmission and spectral filtering. Patterning of a metal film, for example, by creating submicron size holes, pillars or slits, in some of the embodiments enhances near-field light intensity. These enhancements enable detection of smaller changes of chemical and biological materials than previously available SPR based sensors. These enhancements further provide the capability to self-reference. Self-referencing refers to the means of correcting for the optical response due to the uncontrolled variations in ambient conditions such as temperature, pressure and light source intensity drift.

One or more of the embodiments of the methods for detecting biological or biochemical analytes, may generally comprise the steps of: providing a metal film comprising one or more submicron structures; applying one or more analytes to at least a portion of the film surface to functionalize the metal film; illuminating a surface of the metal film with a light source, wherein at least some of the light is optically displaced by the functionalized metal film; collecting the optically displaced light, wherein the displaced light is indicative of surface plasmon resonance on one or more of the surfaces of the film; and detecting one or more properties of the analytes based on the collected light. The submicron structures may comprise nanoholes or nanopillars having a diameter that is less than or equal to 100 nm and may further comprise nanoholes having a diameter that is less than or equal to 50 nm. The pitch of the nanoholes may be 200 nm or less and may further have a pitch that is 100 nm or less. The metal film may comprise gold (Au), silver (Ag), or other suitable metals and may be between 50-250 nm thick. The analytes may comprise a variety of biological or biochemical materials such as, but not limited to, fluorescently labeled materials. The nanopillars may comprise a plurality of composite layers that may, depending on the application, have differing dielectric properties.

The metal film sensor may, depending on the application, be adapted to reflect or displace light so as to produce a refractive index resolution that is less than 10⁻⁸ RIU. The metal film may comprise random or predetermined patterns of submicron structures. The metal film may be freestanding, wholly or partially fixed or otherwise supported on a substrate. The substrate may comprise a variety of materials including, but not limited to, quartz.

Another embodiment of the method for detecting biological or biochemical analytes generally comprises the steps of: providing a metal film comprising one or more submicron structures; applying one or more recognition receptors to one or more of said submicron structures; illuminating a surface of said metal film with a light source, wherein at least some of said light is optically altered by said metal film; collecting said optically altered light, wherein said altered light is indicative of a surface plasmon resonance on said film; and detecting one or more properties of said analytes based on said collected light.

The recognition receptor may comprise a tag submicron structure having a dielectric property that is capable of altering said light; wherein said collected light may comprise light in a transmission mode, in a reflection mode, or both transmission and reflection modes.

The tag used in the sensor may comprise a metal submicron structure and wherein said metal is selected from a group consisting of: Au, Al, Ag, Ni, Pt, Pd, a nobel metal, and a metal having a plasmon resonance in the UV-VIS-IR spectral range. The tag may also comprise a dielectric submicron structure and wherein said dielectric submicron structure comprises a colloidal particle selected from a group consisting of SiO₂ and polystyrene.

The step of collecting light may also comprise collecting light over a spectral range selected to comprise at least one plasmon band; and further comprising the step of analyzing one or more spectral responses using a multivariate analysis wherein said multivariate analysis is adapted to improve said detection. The multivariate analysis may comprise simultaneously analyzing a resonance peak shift, a peak intensity, a peak broadening, a peak shape variation, and a peak distortion.

Another embodiment of the method for detecting biological or biochemical analytes generally comprises the steps of: providing a metal film comprising a plurality of submicron apertures comprising submicron slits having at least one opening; attaching one or more recognition receptors within said opening of at least one nanoslit to functionalized said slit; illuminating a surface of said metal film with a light source, wherein at least a portion of said light is optically altered by said functionalized slit; collecting said optically altered light, wherein said altered light is indicative of plasmon resonance on one or more of said nanoslits; and detecting one or more properties of said analytes based on said collected light.

One or more of the embodiments of the system for detecting biological or biochemical analytes may generally comprise: a metal film having one or more surfaces comprising one or more submicron structures; a device for applying one or more analytes to at least a portion of the film surface to functionalize the metal film; a light source for illuminating a surface of the metal film so that at least some of the light is adapted to be optically displaced by the functionalized metal film; and an optical detection subsystem for collecting the optically displaced light, wherein the displaced light is indicative of surface plasmon resonance on one or more of the surfaces of the film, and detecting one or more properties of the analytes based on the collected light. The system may be adapted to produce displaced light having a reflective index resolution that is less than 10⁻⁸ RIU. Similarly, the submicron structures may comprise nanoholes or nanopillars having a diameter that is less than or equal to 100 nm and may further comprise nanoholes having a diameter that is less than or equal to 50 nm. The pitch of the nanoholes may be 200 nm or less and may further have a pitch that is 100 nm or less. The metal film may comprise gold (Au) and may be between 40-120 nm thick. The analytes may comprise a variety of unlabeled or labeled biological or biochemical materials such, but not limited to, fluorescently labeled materials. The nanopillars may comprise a plurality of composite layers that may, depending on the application, have differing dielectric properties. The metal film may comprise random or predetermined patterns of submicron structures. The metal film may be freestanding, wholly or partially fixed or otherwise supported on a substrate. The substrate may comprise a variety of materials including, but not limited to, quartz.

One or embodiments of the SPR sensor, that is adapted for analyzing biological and biochemical analytes, may generally comprise: a metal film having one or more surfaces comprising one or more submicron structures, wherein the metal film is capable of providing a refractive index resolution that is less than 10⁻⁸ RIU, and wherein the metal film has a surface plasmon resonance. The metal film may be functionalized with one or more biological or biochemical analytes so that the analytes alter the surface plasmon resonance of one or more of the surfaces of the metal film.

### DRAWINGS

These and other features, aspects, and advantages of the present invention will become better understood when the following detailed description is read with reference to the accompanying drawings in which like characters represent like parts throughout the drawings, wherein:

FIG. 1 is a flow diagram of an embodiment of the method of the invention for detecting biochemical material on a functionalized submicron structured metal substrate.

FIG. 2 is a schematic diagram of the system of the invention for detecting biochemical material on a functionalized submicron structured metal substrate.

FIG. 3 is a schematic diagram of an embodiment of a patterned metal film comprising a plurality of submicron size holes.

FIG. 4 is a top view of an embodiment of a patterned metal film comprising a plurality of generally pyramidal submicron holes formed in an Au film.

FIG. 5 is a top view of an embodiment of a patterned metal film comprising a plurality of generally circular submicron holes formed in a metal film, shown in A in a normal SEM image and in B in an enlarged SEM image.

FIG. 6 is a top view of an embodiment of a patterned metal film comprising a plurality of generally circular submicron holes about 35 nm in diameter and ˜200 nm pitch size.

FIG. 7 is a schematic diagram of the optical measurements taken from an embodiment of a patterned metal film in both transmission and reflection modes.

FIG. 8 shows four embodiments of a nanohole array: A) array with submicron holes extending entirely through the metal film to the substrate; B) array with submicron holes partially extending through the metal film with a remaining metal layer between the bottom of the holes and the substrate; C) free-standing array with submicron holes extending entirely through the metal film; D) free-standing array with submicron holes partially extending through the metal film.

FIG. 9 shows two embodiments of a nanohole array: A) array with submicron holes of differing depths through a metal film attached to a substrate; B) free-standing array with submicron holes of differing depths.

FIG. 10 shows two embodiments of submicron hole patterns in metal films.

FIG. 11 shows a top view of two submicron holes and cross-sectional views of three embodiments of a biologically functionalized submicron hole array.

FIG. 12 shows three embodiments of a submicron island (otherwise referred to as submicron pillar) arrays: A) array with submicron islands; B) array with composite submicron islands; C) array with multi-layer composite submicron islands.

FIG. 13 shows three embodiments of functionalized submicron island arrays: A) array with submicron islands functionalized on their top and side surfaces; B) array with composite submicron islands functionalized on their top and side surfaces; C) array with composite submicron islands functionalized on their side surfaces.

FIG. 14 shows an image of an embodiment of a partial array with submicron holes.

FIG. 15 shows an image of an embodiment of an entire array with submicron holes.

### DETAILED DESCRIPTION

The methods and systems overcome the problems of existing GH-SPR techniques and improve SPR sensor detection capabilities. These improvements are in part achieved by one or more of the embodiments by creating a predetermined pattern on a metal film. Arrays of sub-wavelengths apertures provide superior properties for optical systems, such as but not limited to, extraordinary optical transmission and spectral filtering properties. Patterning of the metal film by creating submicron structures in or on the metal film enhances near-field light intensity. Such submicron structures may include but are not limited to nanoholes and nanopillars (also referred to as nanoislands). This enhancement enables detection of more subtle changes in chemical and biological materials and at on smaller scale than unenhanced metal films. Nanoholes refers to depressions or cavities that extend into the metal layer that generally have a definable depth and perimeter. The holes need not be precisely round but are distinguished from elongated grooves. The term nanopillars is interchangeable herein with nanoislands and refers to structures that extend outward from the primary surface of the metal film or substrate and have a definable height and perimeter.

In some of the embodiments, the submicron pattern comprises a plurality of holes or pillars that generally have a diameter that is substantially the same as the wavelengths of light. However, the diameter of the holes or pillars are optimally less than or equal to 100 nm and still more optimally less than or equal to 50 nm, to achieve a refractive index resolution small enough for detecting properties of very small biological and biochemical materials The submicron structures may be patterned randomly or in a predetermined pattern in the film. Non-limiting examples of applicable nano-fabrication technologies that may be used to delineate these submicron structures include but are not limited to nanolithography, nanosphere lithography, ion etching, and others known in the art. The diameter and space pitch of the submicron structures may be adapted or otherwise defined by the given application and generally depend on the function of the wavelength of light. The pitch of the submicron structures is optimally less than or equal to 200 nm and more optimally less than or equal to 100 nm, to achieve a refractive index resolution small enough for detecting properties of very small biological and biochemical materials.

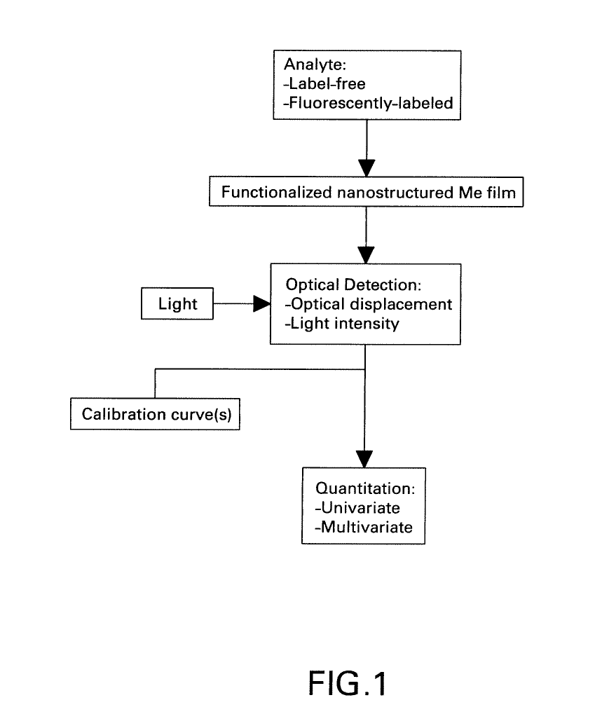

An embodiment of the method of the invention for detecting biological or biochemical analytes is shown in FIG. 1 and generally comprises the steps of: providing a metal film comprising one or more submicron structures; applying one or more analytes to at least a portion of the film surface to functionalize the metal film; illuminating a surface of the metal film with a light source, wherein at least some of the light is optically displaced and collected. The amount and quality of the collected light in part depends on the extent of optical displacement and the intensity of the light. The collected light is indicative of the surface plasmon resonance on one or more of the surfaces of the film, which is altered (when compared to a smooth metal surface) by the submicron structures as well as the analytes. The detected light is then used to analyze and quantify one or more properties of the biological or biochemical analytes. The analytes may be univariate or multivariate.

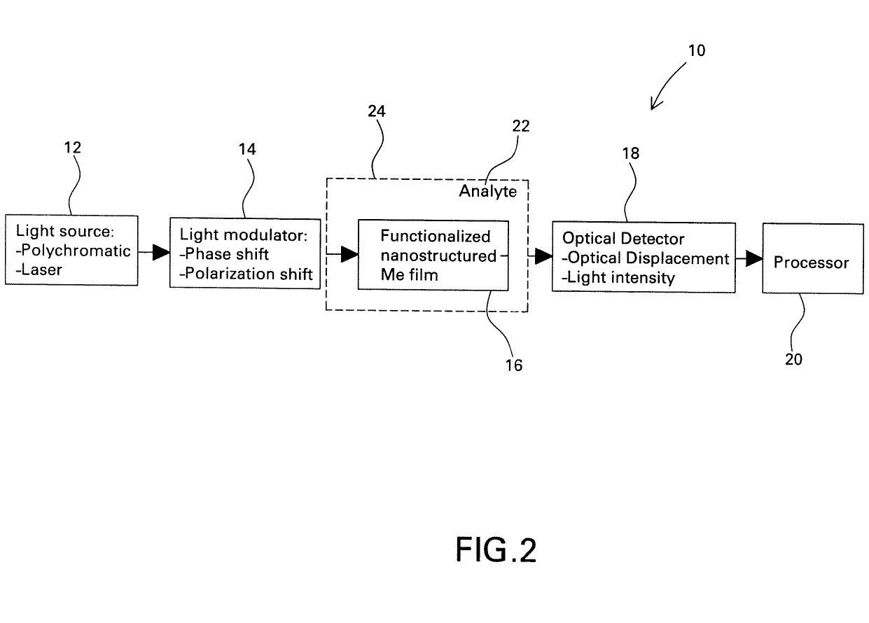

An embodiment of the sensor based system 10 is shown in FIG. 2 and generally comprises a metal film 16 having one or more surfaces comprising one or more submicron structures; a device 24 for applying one or more analytes 22 to at least a portion of the film surface to functionalize the metal film 16; a light source 12 for illuminating a surface of the metal film so that at least some of the light is adapted to be optically displaced by the functionalized metal film; a optical detection subsystem 18 for collecting the optically displaced light, wherein the displaced light is indicative of surface plasmon resonance on one or more of the surfaces of the film, and detecting one or more properties of the analytes based on the collected light. The light source 12 may be a variety of suitable light sources including but not limited to polychromatic illumination devices and lasers. System 10 may comprise a light modulator 14 to shift the phase or polarization of the light. The system need not comprise the device 24 for applying the analytes. In such embodiments, the system generally comprises illumination and detection components, into which the metal film sensor or sensors are loaded, with the one or more analytes already previously applied to the metal film. Any one of the embodiments of the system may comprise one or more processing devices 20 for processing the data collected from the illumination and detection components to generate biologically and biochemically relevant information from the data.

In one or more of the embodiments of the methods and systems, a chemical and/or biological sensitive material is applied onto a metal film that comprises plurality of random or predetermined patterned submicron structures. The biochemically sensitive material may be deposited on the metal film using a variety of techniques including, but not limited to, arraying, ink-jet printing, screen printing, vapor deposition, spraying, draw coating, and other deposition methods known in the art. The biological or biochemical materials may be labeled or label-free. Labeled materials may be labeled or marked with any number and type of markers and dyes, such as fluorescent dyes, including but not limited to: cytological or morphological stains, immunological stains such as immunohisto- and immunocyto-chemistry stains, cytogenetical stains, in situ hybridization stains, cytochemical stains, DNA and chromosome markers, and substrate binding assay stains. For example, such markers and dyes may include but are not limited to: Her2/neu, EGF-R/erbB (epidermal growth factor receptor), ER (estrogen receptor), PR (progesterone receptor), AR (androgen receptor), P53 (tumor suppressor gene), β-catenin (oncogene), phospho-β-catenin (phosphorylated form of β-catenin), GSK3β (glycogen synthase kinase-3β protein), PKCβ (mediator G-protein coupled receptor), NFKβ (nuclear factor kappa B), Bcl-2 (B cell lymphoma oncogene 2), CyclinD (cell cycle control), VEGF (vascular endothelial growth factor), E-cadherin (cell-to-cell interaction molecule), c-met (tyrosine kinase receptor), keratin, pan-cadherin, smooth muscle actin, DAPI, hematoxylin, eosin.

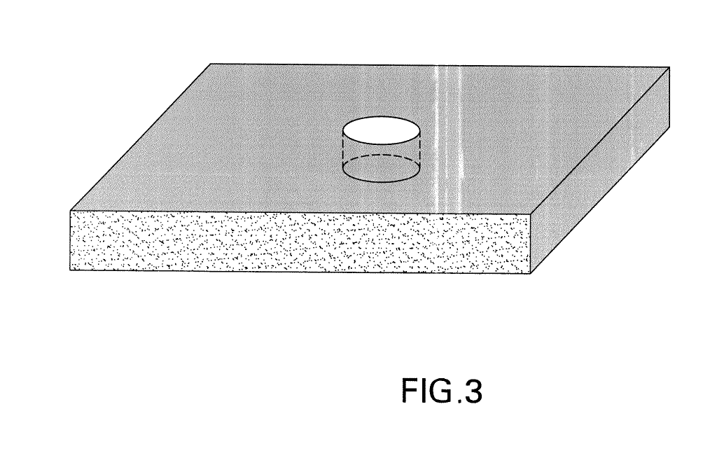

When the biological or biochemical materials are applied to the metal film, the materials interact with the metal film. This interaction affects the electro-optical properties of the film, which effectively alters the SPR or refractive index response of the metal film sensor. Fabrication of the nanostructured metal films is generally shown in FIG. 3.

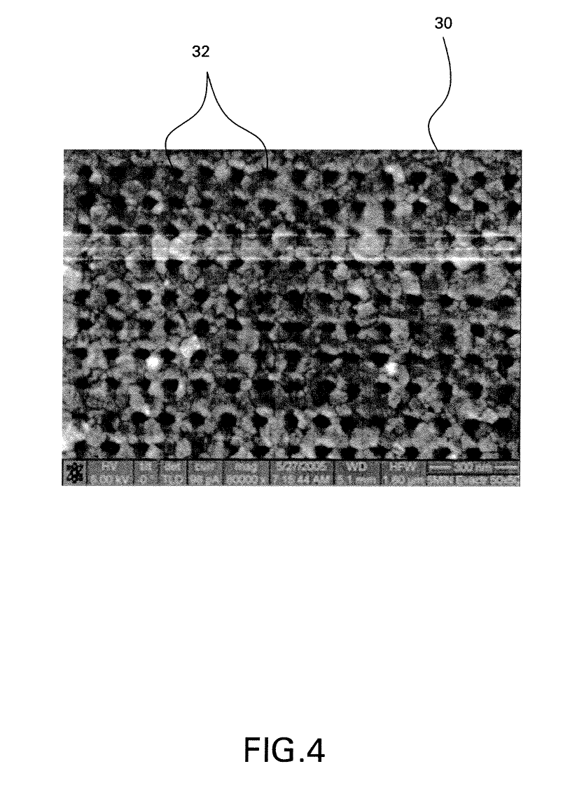

As an example, holes for some of the embodiments of the sensors were produced using a focused ion beam milling (FIB) system (FEI NOVA 200 Dual Beam FIB-SEM). The application of this system provided a precise depth control of fabricated nanoholes with precision of ˜5 nm. Pitch between the holes was controlled with resolution of about 5 nm. The FIB tool provided large patterned areas on the millimeter scale. FIB patterning did not cause undesirable surface damage. Patterns were produced in Au films that were deposited on quartz. The Au film thickness was between 40-120 nm. Further examples of the nanostructured metal films are shown in FIGS. 4, 5 and 6.

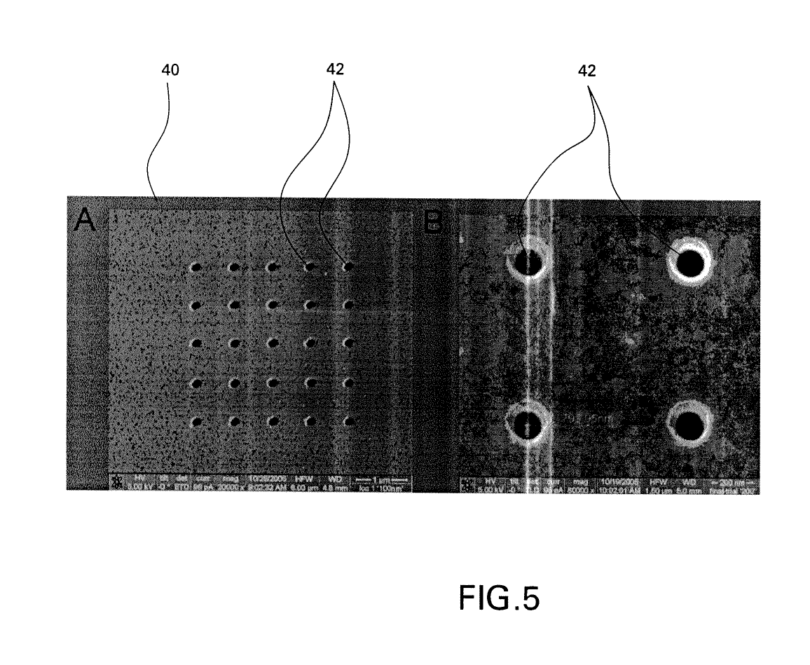

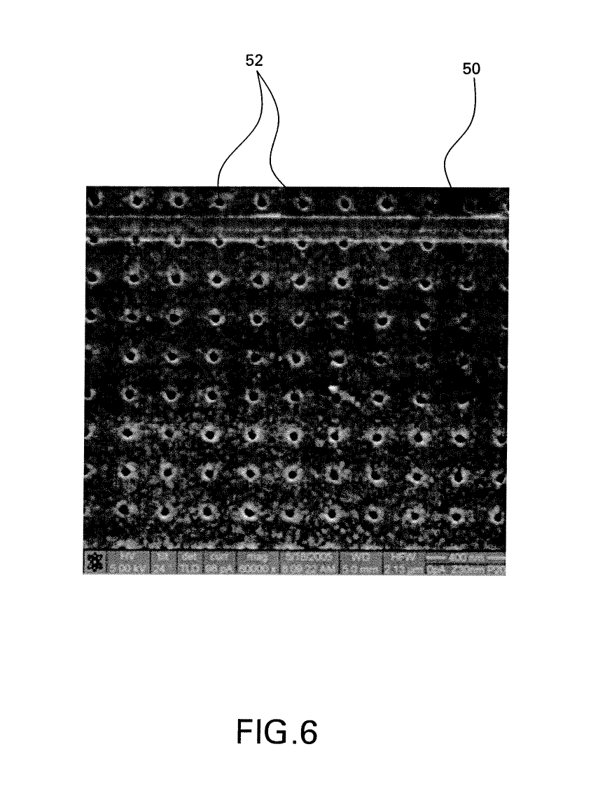

FIG. 4 shows a metal film 30 (also referred to as an array) with nanoholes 32 in the form of pyramids that are formed in a gold (Au) film. Patterning was performed on a 50×50 μm area with a 100 nm pitch. FIGS. 5A and 5B show a 5×5 array 40 of circular nanoholes 42 of about 35 nm in diameter and ˜800 nm pitch size. FIG. 5A is general SEM view of the 5×5 array and FIG. 5B is a portion of the same array at a greater magnification. FIG. 6 shows an array 50 of circular nanoholes 52 of about 35 nm in diameter and ˜200 nm pitch size.

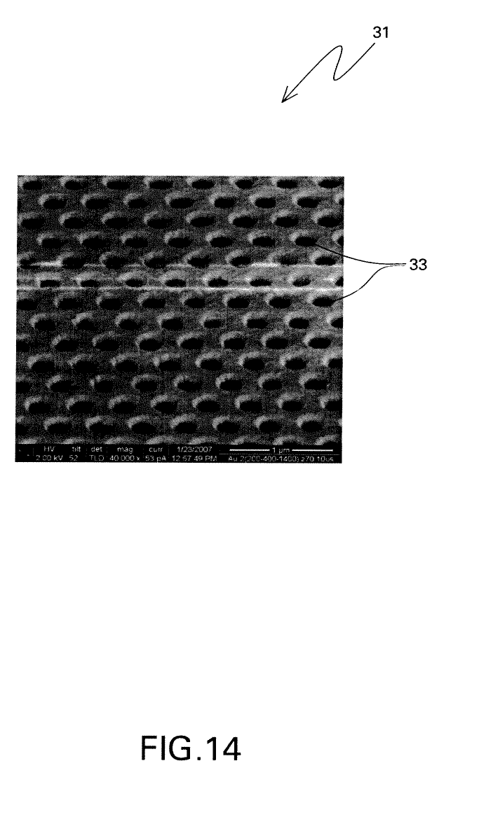

FIG. 14 shows a metal film 31 (also referred to as an array) with holes 33 in the form of circles that are formed in a gold film. Patterning was performed on a 30×30 μm area with a 500 nm pitch and about 210 nm diameter holes. FIG. 14 is an SEM image of a portion of a fabricated array.

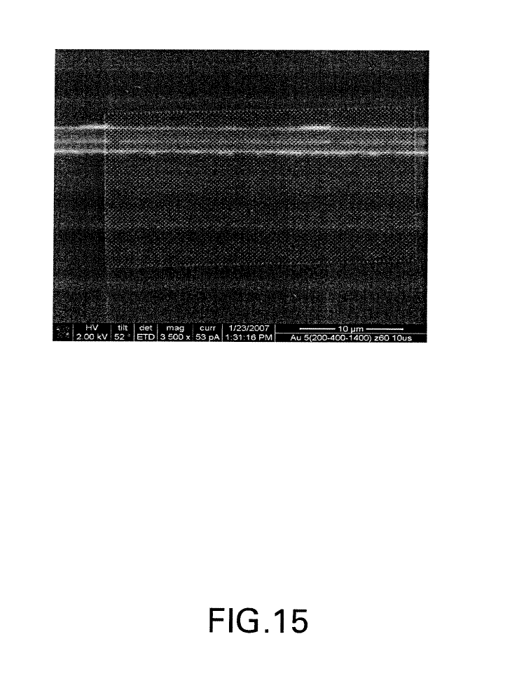

FIG. 15 shows a metal film 35 (also referred to as an array) with holes 37 in the form of circles that are formed in a gold film. Patterning was performed on a 30×30 μm area with a 400 nm pitch and about 180 nm diameter holes. FIG. 15 is also an SEM image of an entire array. The SEM image of this square array was taken at a 52° tilt of the metal film.

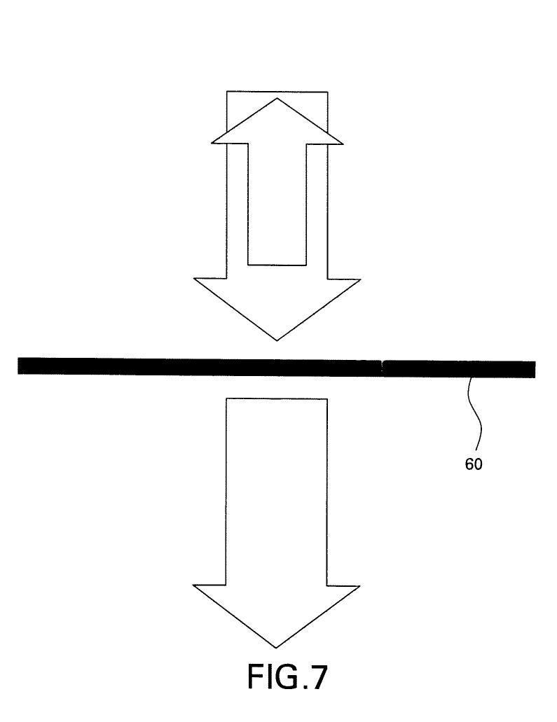

FIG. 7 illustrates the transmission and reflection modes demonstrate how the optical measurements may be taken from a nanostructure array 60. The nanostructure array may comprise on holes or islands (pillars). As noted, holes may be formed in the metal film, for example, using focused ion beam (FIB) milling. Pillars may be formed on a substrate, for example, using nanolithography, chemical vapor deposition, metal sputtering, ion etching, and others known in the art.

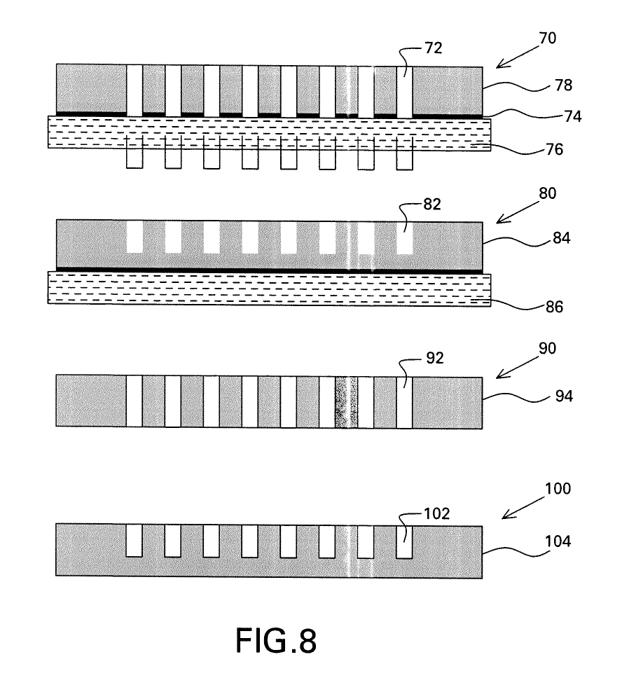

FIG. 8 illustrates several embodiments where nanohole arrays are formed through the entire metal film thickness or with a certain remaining thickness of metal in the film. These metal films with nanohole arrays are either on a substrate or free standing. Array 70 is shown with nanoholes 72 extending entirely through metal film 78 and adhesive layer 74. Adhesive layer 74 is used to fix metal film 78 to substrate 76. Substrate 76 may comprise a number of suitable types of transmissive materials such as quartz. Other useful metal include, but are not limited to, aluminum and silver. The adhesion layer promotes adhesion of gold to the glass surface. Examples of suitable adhesives include, but are not limited to, chromium and titanium. Examples of substrate materials include, but are not limited to, glass, quartz, silicon, magnesium fluoride, calcium fluoride, and polymers such as polycarbonate, Teflon AF, and Nafion. Array 80 is shown with nanoholes 82 extending partially through metal layer 84. Metal layer 84 is similarly fixed to substrate 86. Array 90 is shown with nanoholes 92 extending entirely through metal film 94 which is free standing. Array 100 is another free standing embodiment shown with nanoholes 102 extending partially through metal film 104. It is also envisioned that a metal film may be seated partially on a substrate and yet be partially free standing, depending on the application.

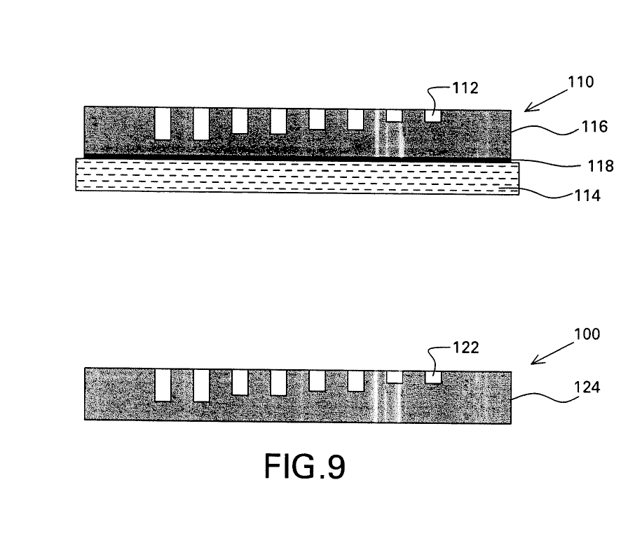

FIG. 9 shows two embodiments where nanohole arrays are formed with different depth of holes in the metal film. Array 110 is shown with nanoholes 112 having differing depths into metal film 116. Metal film 116 is fixed to substrate 114 using adhesive 118. Both substrate 114 and adhesive 118 may comprise a variety of suitably transmissive materials. Array 120 is shown with nanoholes 112 having differing depths into freestanding metal film 124.

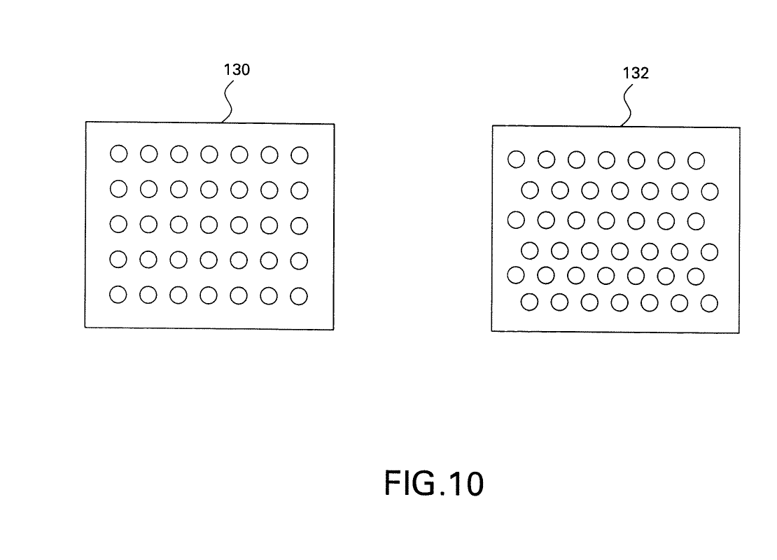

FIG. 10 shows two example embodiments of arrays 130 and 132 with different geometries of nanohole patterns in the metal film. These patterns and geometries are not limiting. Any suitable pattern and geometry may be used depending on the application.

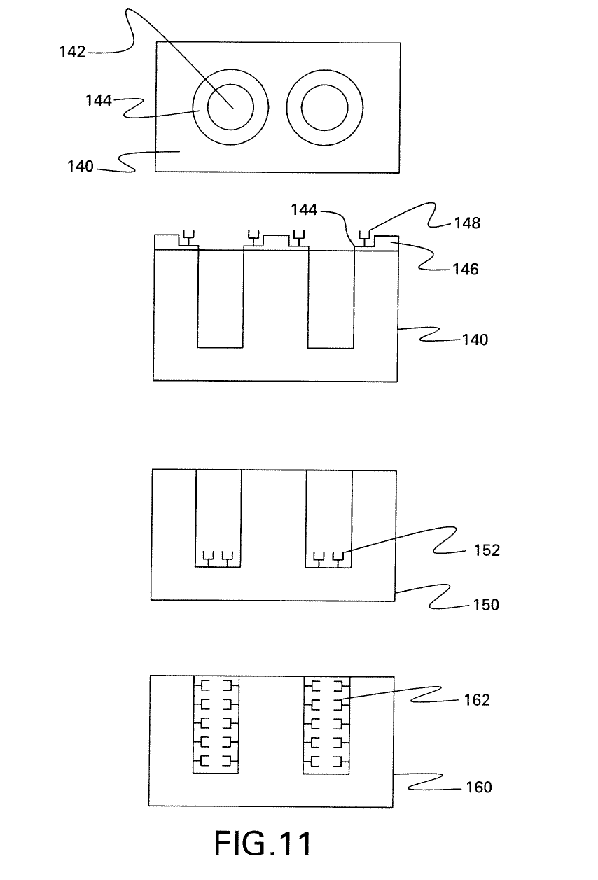

FIG. 11 shows several example embodiments of biologically functionalized nanohole array structures. In one embodiment, the metal film 140 (for example gold) is coated with a thin (nanometers thick) layer of another metal 146 (for example gallium). This deposition is done using a FIB system. Next, the FIB is used to remove a region of gallium metal film and to produce a nanohole 142 in a gold film. Thus, the gold nanohole has a ring 144 around it of bare gold film. This area of gold is further used for attachment of biological recognition receptors 148. An example of attachment method is a thiol-chemistry based method. A similar receptor-attachment method is used for attachment of receptors 152 onto the bottom of array 150 and receptors 162 onto the sides of the holes in array 160.

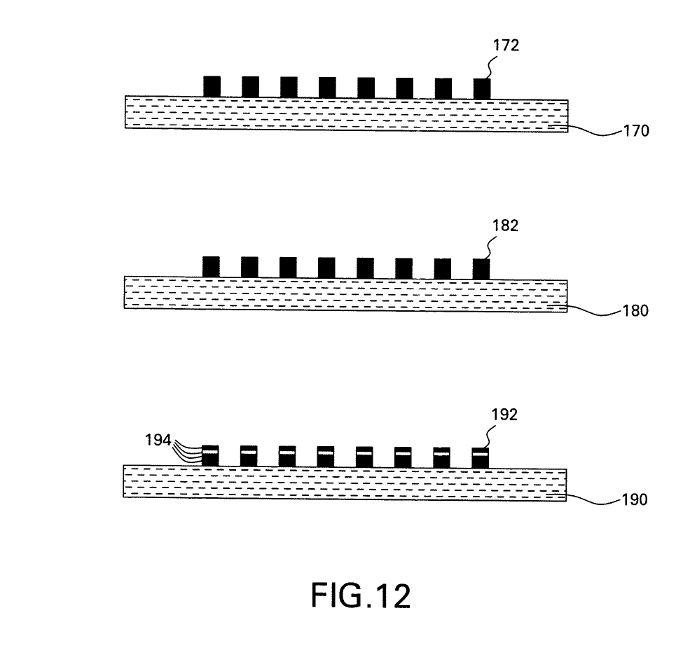

FIG. 12 shows several examples of nanopillar (nanoisland) structures where the nanopillars are formed from a single material or comprise a composite structure of differing or alternating materials. These materials may have different dielectric properties. Array 170 is shown with a plurality of islands 172. Array 180 is shown with a plurality of composite islands 182. Array 190 is shown with a plurality of composite islands 192 which comprise a plurality of composite layers 194 having differing dielectric properties. The pillars or island may be created using electron beam lithography. In this process, the radiation sensitive film or resist is placed in the vacuum chamber of a scanning beam electron microscope and exposed by an electron beam. After exposure, the film is removed from the vacuum chamber for conventional development and other production processes. This process allows delineation of the desirable shape of each nanopillar and provides nanometer level of resolution. By repeating the electron beam patterning (exposure together with development) steps with layers of different films, the multilayer structures are formed with nanometer precision. This process may be used for nanoapertures as well as nanopillars.

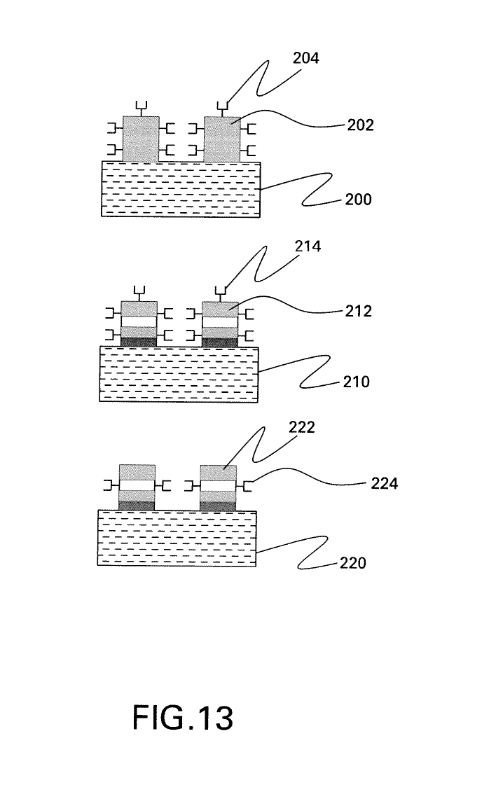

FIG. 13 shows several examples of biologically functionalized nanoisland array structures. In one embodiment, array 200 is shown with a plurality of nanoislands 202 functionalized on the top and sides with biological receptors 204. Array 210 is shown with a plurality of composite nanoislands 212 functionalized on the top and sides with bioreceptors 214. Array 220 is shown with composite nanoislands 222 functionalized on the sides with bioreceptors 224.

The enhancements described in part provide the capability to self-reference. Self-referencing refers to the means of correcting for the optical response due to the uncontrolled variations in ambient conditions such as temperature, pressure and light source intensity drift. In optical measurements based on the detection of intensity of light at a single wavelength or at multiple wavelengths, the fluctuations of the light source intensity, detector sensitivity, and temperature instability of the sensor chip, cause the change in the measured signal that is not related to the analyte concentration, but rather to these and other known noise sources.

Using the enhancements of the methods and system, it is possible then to compensate for these sources of signal fluctuation. One alternative is based on the use of two sensor chips, where one separate chip is made with a sensing film. Another separate chip is made without the sensing film. Measurements are performed on both chips and signal from reference chip is used to correct for unexpected effects not related to the analyte binding. However, by using two chips, there may still be a remaining issue to resolve. These chips experience different effects because they are two different chips and are exposed to two different conditions or regions of the sample flow. Thus, the enhancements enable a single chip to do both sensing and referencing. For example, one of such embodiments uses polarization interferometry, where one polarization of light is used as a reference while another polarization, is used for sensing.

In one or more of the methods, the same chip is used for both measurements, reference and sensing. Several closely spaced regions are used on a single chip for sensing and referencing. The sensing and reference regions are defined by the array of nanoslits and correspond to the opaque space between the slits and the slits themselves. For example, the space between the slits is a reference region and the functionalized slits are sensing regions. As a further example, the functionalized space between the slits may be used as a sensing region and the slits used as a reference region. When using a single chip with a slit array, for referencing and sensing, either a naturally polarized light or with a linearly polarized light may be used. The linearly polarized light used for sensing and referencing has the same or different polarizations.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for detecting biological or biochemical analytes comprising the steps of,
providing a metal film comprising one or more submicron structures;
applying one or more analytes to at least a portion of said film surface to interact with said metal film;
illuminating a surface of said metal film with a light source, wherein at least some of said light is optically altered by said metal film;
collecting said optically altered light, wherein said displaced light is indicative of a surface plasmon resonance on said film; and
detecting one or more properties of said analytes based on said collected light.

2. The method of claim 1, wherein said altered light is indicative of a refractive index of said analyte.

3. The method of claim 1, wherein said submicron structures comprise submicron apertures having a diameter that is 5-1500 nm.

4. The method of claim 3, wherein said submicron structures comprise submicron apertures having an opening that is 5-1500 nm.

5. The method of claim 4, wherein a plurality of said apertures have a pitch that is 200 nm or less.

6. The method of claim 5, wherein a plurality of said apertures have a pitch that is 100 nm or less.

7. The method of claim 1, wherein said metal film is a Au film that is between 40-320 nm thick.

8. The method of claim 5, wherein said submicron structures comprise submicron apertures having a diameter that is less than or equal to 100 nm.

9. The method of claim 6, wherein said analytes comprise a fluorescently-labeled biological or biochemical material.

10. The method of claim 1, wherein said submicron structures comprise nanopillars having at least one dimension that is less than or equal to 100 nm.

11. The method of claim 8, wherein said submicron structures comprise nanopillars having at least one dimension that is less than or equal to 50 nm.

12. The method of claim 9, wherein said analytes comprise a fluorescently-labeled biological or biochemical material.

13. The method of claim 10, wherein one or more of said nanopillars comprise a plurality of composite layers.

14. The method of claim 13, wherein two or more of said composite layers have different dielectric properties from each other.

15. The method of claim 8, wherein a plurality of said submicron structures have a pitch that is less than 200 nm.

16. The method of claim 14, wherein a plurality of said submicron structures have a pitch that is less than 100 nm.

17. The method of claim 1, wherein said metal film comprises a predetermined pattern of submicron structures.

18. The method of claim 1, wherein said metal film is provided on a substrate.

19. The method of claim 18, wherein said substrate comprises quartz.

20. A system for detecting biological or biochemical analytes comprising,
a metal film having one or more surfaces comprising one or more submicron structures;
a device for applying one or more analytes to at least a portion of said film surface to interact with said metal film;
a light source for illuminating a surface of said metal film so that at least some of said light is adapted to be optically altered by said metal film; and
an optical detection subsystem for collecting said optically displaced light, wherein said displaced light is indicative of surface plasmon resonance on one or more of said surfaces of said film, and detecting one or more properties of said analytes based on said collected light.

21. The system of claim 20, wherein said submicron structures comprise nanoholes having a diameter that is less than or equal to 50 nm.

22. The system of claim 21, wherein one or more of said nanoholes are surrounded by a ring of Au.

23. The system of claim 22, wherein one or more of said analytes are on at least a portion of said ring.

24. The system of claim 21, wherein one or more of said nanoholes have an inner surface that comprises Au and wherein one or more recognition receptors are provided on at least a portion of said Au inner surface.

25. The system of claim 20, wherein said film comprises an inert layer to which one or more of said analytes do not interact.

26. The system of claim 20, wherein a plurality of submicron structures have a pitch that is less than or equal to 100 nm.

27. The system of claim 20, wherein said submicron structures comprise nanopillars having at least one dimension that is less than or equal to 50 nm.

28. The system of claim 27, wherein a plurality of said submicron structures have a pitch that is less than or equal to 100 nm.

29. The system of claim 27, wherein one or more of said nanopillars comprises a plurality of composite layers, wherein said composite layers have differing dielectric properties from each other.

30. A sensor adapted for analyzing biological and biochemical analytes, comprising,
a metal film having one or more surfaces comprising one or more submicron structures, wherein said metal film is capable of providing a refractive index resolution that is less than 10⁻⁸ RIU, and wherein said metal film has a surface plasmon resonance.

31. The sensor of claim 30, wherein said metal film is functionalized with one or more biological or biochemical analytes so that said analytes alter said surface plasmon resonance of one or more of said surfaces of said metal film.

32. A method for detecting biological or biochemical analytes comprising the steps of,
providing a metal film comprising one or more submicron structures;
applying one or more recognition receptors to one or more of said submicron structures;
illuminating a surface of said metal film with a light source, wherein at least some of said light is optically altered by said metal film;
collecting said optically altered light, wherein said altered light is indicative of a surface plasmon resonance on said film; and
detecting one or more properties of said analytes based on said collected light.

33. The method of claim 32, wherein said recognition receptor comprises a tag submicron structure having a dielectric property that is capable of altering said light.

34. The method of claim 32, wherein said collected light comprises light in a transmission mode, in a reflection mode, or both transmission and reflection modes.

35. The method of claim 32, wherein said step of collecting light comprises collecting light over a spectral range selected to comprise at least one plasmon band; and further comprising the step of analyzing one or more spectral responses using a multivariate analysis.

36. The method of claim 35, wherein said multivariate analysis is adapted to improve said detection.

37. The method of claim 36, wherein said multivariate analysis comprises analyzing a resonance peak shift, a peak intensity, a peak broadening, a peak shape variation, and a peak distortion.

38. The method of claim 33, wherein said tag comprises a metal submicron structure and wherein said metal is selected from a group consisting of: Au, Al, Ag, Ni, Pt, Pd, a nobel metal, and a metal having a plasmon resonance in the UV-VIS-IR spectral range.

39. The method of claim 33, wherein said tag comprises a dielectric submicron structure and wherein said dielectric submicron structure comprises a colloidal particle selected from a group consisting of SiO₂ and polystyrene.

40. A method for detecting biological or biochemical analytes comprising the steps of,
providing a metal film comprising a plurality of submicron apertures comprising submicron slits having at least one opening;
attaching one or more recognition receptors within said opening of at least one nanoslit to functionalized said slit;
illuminating a surface of said metal film with a light source, wherein at least a portion of said light is optically altered by said functionalized slit;
collecting said optically altered light, wherein said altered light is indicative of plasmon resonance on one or more of said nanoslits; and
detecting one or more properties of said analytes based on said collected light.
